(19) United States
(12) Patent Application Publication
(10) Pub. No.: US 2012/0138824 A1
(43) Pub. Date: Jun. 7, 2012

(54) CONTINUOUS LIQUID LEVEL SENSOR HAVING MULTIPLE LIGHT SOURCES AND LIGHT RECEIVING DEVICES

(76) Inventors: Fang Wen, Irvine, CA (US); Yan Fang, Irvine, CA (US)

(21) Appl. No.: 12/960,354

(22) Filed: Dec. 3, 2010

(51) Int. Cl. G01F 23/292

(52) U.S. Cl. 250/575

(57) ABSTRACT

The invention provides an optical continuous liquid level sensor used to determine the level of a liquid within a vessel. The sensor includes one or a plurality of light sources located at various height levels, a plurality of light receiving devices located at various height levels, at least one optical lens in front of the light sources and the light receiving devices, and at least one processor connected to the light sources and the light receiving devices, which processor is capable of transmitting outgoing signals to the light sources, receiving reflected signals from the light receiving devices, processing related signal information so as to determine the liquid level continuously. Baseline data can be obtained by placing the entire level sensor in the air.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to continuous liquid level sensors, and more particularly, to optical continuous liquid level sensors capable of providing liquid level and baseline information using at least one optical light sources, a plurality of light receiving devices and at least one optical lenses.

2. Description of the Related Art

Liquid level sensors are widely used in various fields of art, including automotive, medical device, civil, aerospace and military applications. Several techniques exist for measuring a liquid level. In one conventional approach, a mechanical float that rides on the surface of a liquid may be used to measure the liquid level relative to a float attachment point. The mechanical float is complex in practice and may not be used with high viscosity liquids.

Electrical techniques for measuring a liquid level are also known. In one approach, a capacitor is formed by one facing metal plate and the liquid as the other plate. As the liquid level varies, the capacitance changes. The relation between liquid level and capacitance may be calibrated. However, the measured result is sensitive to temperature, humidity, environmental vibration and dust. Hence all the above factors easily affect the measurement accuracy. In addition, if the liquid type changes, a recalibration is required.

Ultrasound techniques are also available. Ultrasonic level sensors are used for non-contact level sensing of highly viscous liquids, as well as bulk solids. In one approach, the sensor emits high frequency (20 KHz to 200 KHz) acoustic waves that are reflected back to and detected by the emitting transducer. The time of flight can be measured and used to determine the liquid level. However, ultrasonic level sensors are easily affected by the changing speed of sound due to moisture, temperature and pressures. Moreover, since the ultrasonic transducer is used for both transmitting and receiving the acoustic energy, it is subject to a period of mechanical vibration known as “ringing” which causes a blanking zone, typically 150 mm to 1 m, depending on the range of the transducer.

Optical techniques are also available. In one approach, a light beam is directed from a source vertically through the container to a detector. The reduction in measured intensity of the light beam is a measure of the liquid level. However, this method limits the depth of liquid that may be measured due to the attenuation of the light in the liquid. It is also sensitive to influences such bubbles in the liquid, currents in the liquid, and the like. Moreover, multipath reflections of light in a restricted space may interfere with the measurement result which limits the technology to large size or open space applications. In another approach, a light beam is directed vertically downward from a light source to a dome shaped or conical shaped optical lens. Only one light source and one light receiving device are used. If the lens is in contact with a liquid, less light will be reflected back upward and received by the light receiving device. If the lens is in contact with air, more light will be reflected back and received by the light receiving device due to total reflection. The measured intensity of the reflected light beam is a measure of the liquid level. However, this method is usually used for point level sensing.

Although there are various techniques for measuring liquid level, they present various difficulties as discussed above. The present invention overcomes the above difficulties. The present invention includes one or a plurality of light sources and a plurality of light receiving devices. Light is directed approximately horizontally from the light sources to a lens, and reflected from the lens into the light receiving devices. The present invention is easy to manufacture. It is not sensitive to liquid temperature, liquid type, humidity, and environmental vibration. It has no blanking zone. It is not sensitive to bubbles and currents in the liquid. Moreover, the present invention provides continuous level sensing with a wide range of liquid depth.

### BRIEF SUMMARY OF THE INVENTION

The invention provides a continuous optical liquid level sensor which comprises:

a) one or a plurality of light sources located at various height levels, which light sources are capable of receiving signal information from at least one processor and transmitting outgoing optical signals to at least one optical lens;

b) a plurality of light receiving devices located at various height levels, which light receiving devices are capable of receiving reflected optical signals from said optical lens and sending reflected signal information to said processor;

c) at least one optical lens in front of said light sources and said light receiving devices, which optical lens is capable of receiving optical signals from said light sources, forming reflected optical signals, and passing the reflected optical signals to said light receiving devices;

d) at least one processor connected to said light sources and said light receiving devices, which processor is capable of transmitting outgoing signals to said light sources, receiving reflected signals from said light receiving devices, and processing related signal information.

The invention also provides a method of sensing the depth of a liquid which comprises:

I) providing an optical liquid level sensor which comprises:

a) one or a plurality of light sources located at various height levels, which light sources are capable of receiving signal information from at least one processor and transmitting outgoing optical signals to at least one optical lens;

b) a plurality of light receiving devices located at various height levels, which light receiving devices are capable of receiving reflected optical signals from said optical lens and sending reflected signal information to said processor;

c) at least one optical lens in front of said light sources and said light receiving devices, which optical lens is capable of receiving optical signals from said light sources, forming reflected optical signals, and passing the reflected optical signals to said light receiving devices;

d) at least one processor connected to said light sources and said light receiving devices, which processor is capable of transmitting outgoing signals to said light sources, receiving reflected signals from said light receiving devices, and processing related signal information;

II) making at least a portion of said optical lens in contact with a liquid whose level is to be measured;

III) sending outgoing signal information from said processor to all said light sources, causing all said light sources transmitting outgoing light beams to said optical lens;

IV) forming reflected optical signals at said optical lens;

V) receiving said reflected optical signals into said light receiving devices;

VI) sending reflected signals information from said light receiving devices to said processor; and

VII) processing the reflected signals information via said processor.

Accordingly, several advantages of the present invention are:

a) To provide a liquid level sensor which has simple structure, is easy to manufacture and easy to maintain.

b) To provide a liquid level sensor which has adjustable resolution.

c) To provide a liquid level sensor which provides baseline information and has high measuring accuracy.

d) To provide a liquid level sensor which is not sensitive to liquid temperature, moisture, and environmental vibration.

e) To provide a liquid level sensor which has no blanking zone.

f) To provide a liquid level sensor which is not sensitive to bubbles and currents in the liquid because the light intensity discontinuity pattern caused by air liquid interface is different from that caused by bubbles and currents.

g) To provide a liquid level sensor which provides continuous liquid level sensing function for a wide range of liquid depth.

h) To provide a liquid level sensor which provides various user interfaces, and easy to be integrated in an existing system.

Further features and advantages of the present invention will be apparent from a consideration of the following detailed description of the preferred embodiments and accompanying drawings, which illustrates, by way of example, the principles of the invention. However the scope of the invention is not limited to the preferred embodiments.

### BRIEF DESCRIPTION OF THE SEVERAL VIEWS OF THE DRAWINGS

FIG. 1 provides a schematic representation of a first and second preferred embodiment of a liquid level sensor of the invention.

FIG. 2 shows a sectional view of the first and second preferred embodiment of a liquid level sensor of the invention, taken on line 2-2 of FIG. 1.

FIG. 3 shows a sectional view of the first preferred embodiment of a liquid level sensor of the invention, taken on line 3-3 of FIG. 1 wherein the air is in contact with that portion of the lens when optical signals are sent to the lens from the light sources.

FIG. 4 shows a sectional view of the first preferred embodiment of a liquid level sensor of the invention, taken on line 4-4 of FIG. 1 wherein a liquid is in contact with that portion of the lens when optical signals are sent to the lens from the light sources.

FIG. 5 provides a sectional view of the second preferred embodiment of a liquid level sensor of the invention, taken on line 4-4 of FIG. 1 wherein a liquid is in contact with that portion of the lens when optical signals are sent to the lens from the light sources.

FIG. 6 provides an exploded view of a third embodiment of a liquid level sensor of the invention.

FIG. 7 provides a schematic representation of a fourth embodiment of a liquid level sensor of the invention.

### DETAILED DESCRIPTION OF THE INVENTION

The invention provides a continuous liquid level sensor used to determine the level of a liquid within a vessel. While the figures show preferred configurations of the invention, alternate configurations may be contemplated by those skilled in the art.

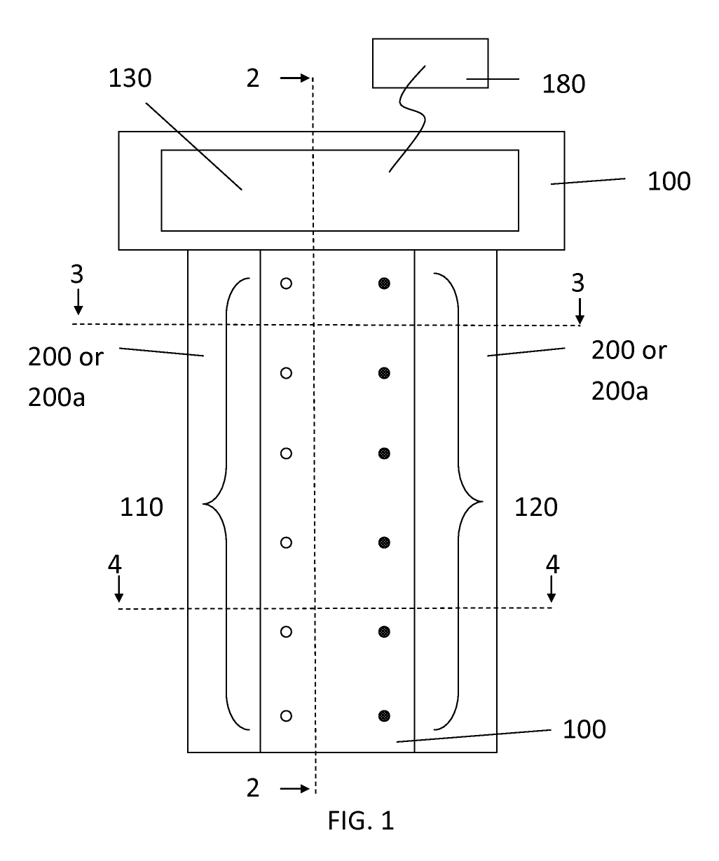

As shown in FIG. 1, a schematic view of a first and second preferred embodiment of a liquid level sensor of the invention, the optical liquid level sensor includes an elongated circuit 100. In the circuit 100, a plurality of light sources 110 are positioned as one vertical line, and a plurality of light receiving devices 120 are positioned as another vertical line. Each light source 110 has a corresponding light receiving device 120. In the preferred embodiments, the number of the light sources 110 and the number of the light receiving devices 120 are identical. In some variations, the total number of light sources 110 does not have to be the same as the total number of light receiving devices 120. For example, three light sources may share one corresponding light receiving devices, or one light source may have three corresponding light receiving devices. In the preferred embodiments, an optical lens 200 or 200a is placed in front of the light sources 110 and the light receiving devices 120. A light beam is directed approximately horizontally from each light source 110 to the optical lens 200 or 200a. At least part of the light beam is reflected from the optical lens 200 or 200a to the corresponding light receiving device 120. The circuit 100 also includes a processor circuit 130. The processor circuit 130 is connected to the light sources 110 and the light receiving devices 120 electronically. It is capable of transmitting electronic signals to the light sources 110, receiving electronic signals containing reflected light intensity information from the light receiving devices 120, processing related signal information, and communicate with users via parallel or serial user interfaces.

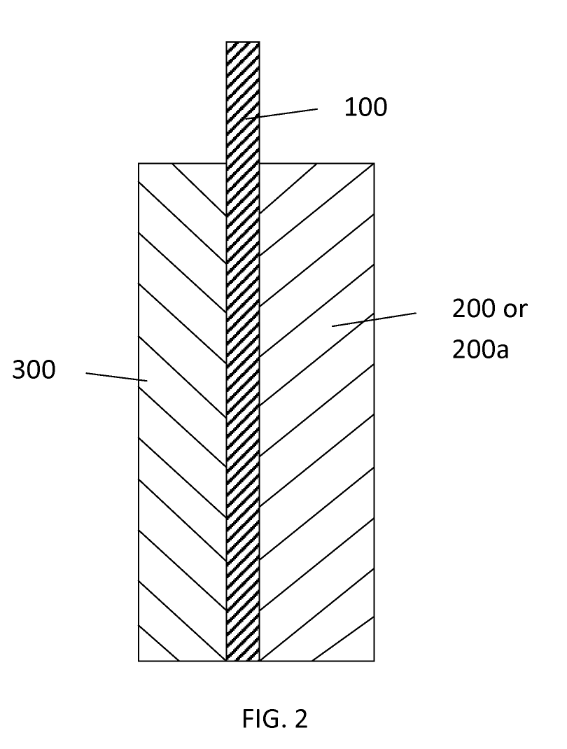

FIG. 2 is a sectional view of the first and second preferred embodiment of a liquid level sensor of the invention, taken on line 2-2 of FIG. 1. As shown in FIG. 2, the optical liquid level sensor includes an elongated part 300. Part 300 and lens 200 or 200a encase at least a portion of the circuit 100 so that the circuit 100 is not in direct contact with a liquid when the level sensor is immersed in the liquid. The optical lens 200 or 200a has a shape that cause more light to be reflected back to the light receiving devices when it is in contact with the air than when it is in contact with a liquid due to complete internal reflection. This type of liquid level sensor can be placed inside the liquid vessel entirely.

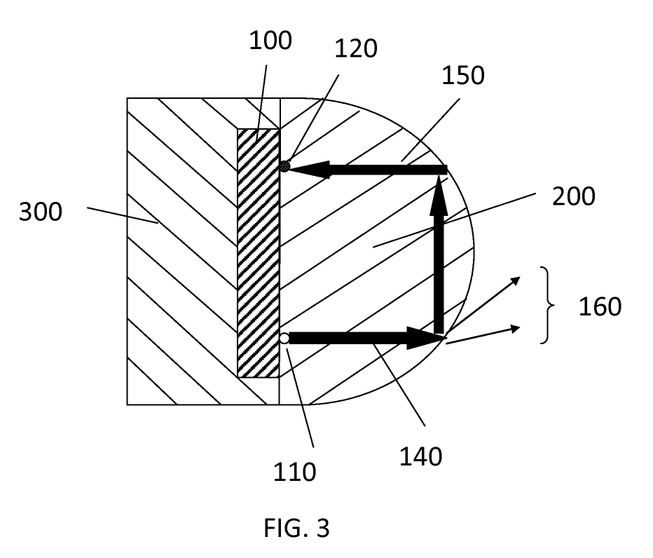

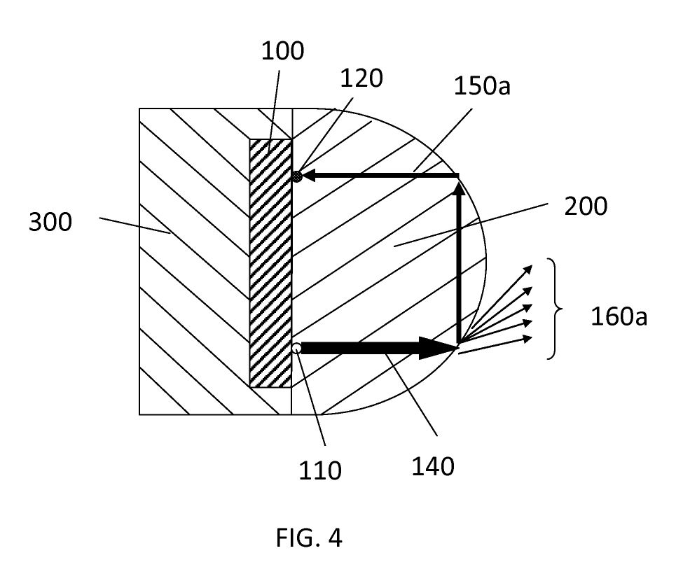

FIG. 3 is a sectional view of the first preferred embodiment of a liquid level sensor of the invention, taken on line 3-3 of FIG. 1. As shown in FIG. 3, light signal 140 is directed to the lens 200 from the light source 110. The sectional view of the lens 200 is a filled half circle. That portion of the lens 200 is in contact with the air. In this situation, most of the light signal 140 is reflected due to complete internal reflection, resulting in a stronger reflected light signal 150 and less escaped light 160. Conversely, as shown in FIG. 4, a sectional view of the first preferred embodiment of a liquid level sensor of the invention, taken on line 4-4 of FIG. 1 wherein a liquid is in contact with that portion of the lens 200, in this situation, less of the light signal 140 is reflected, resulting in a weaker reflected light signal 150a and more escaped light 160a.

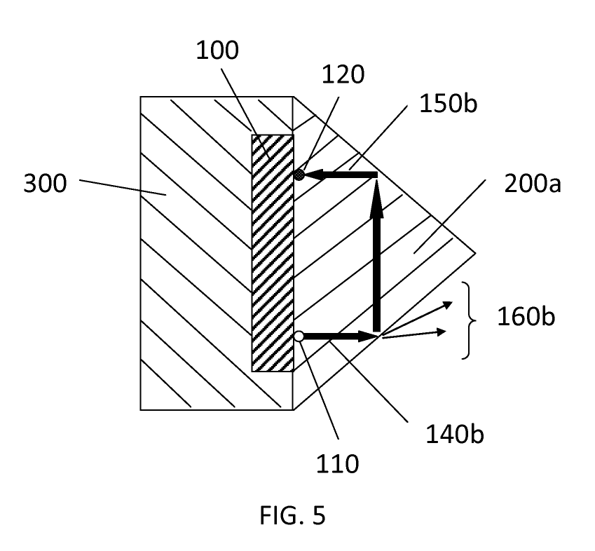

FIG. 5 is a sectional view of a second embodiment of a liquid level sensor of the invention, taken on line 3-3 of FIG. 1 wherein the air is in contact with that portion of the lens 200a. As shown in FIG. 5, the sectional view of the lens 200a is a filled triangle. The lens 200a works similarly to the lens 200. Stronger reflected optical signal will be received by the light receiving devices when the air is in contact with that portion of the lens 200a due to complete internal reflection. Weaker reflected optical signal will be received by the light receiving devices when a liquid is in contact with that portion of the lens 200a. While FIG. 3, FIG. 4, and FIG. 5 show preferred configurations of the invention, a lens with other shapes may be used here as long as the lens can cause more light to be reflected to the light receiving devices when the lens is in contact with the air than when the lens is in contact with a liquid.

The light sources 110 may comprise any suitable conventionally known light sources, preferably Light Emitting Diodes (LEDs), Laser diodes, Lamps, or light pipes. Although there are multiple light sources shown in the preferred embodiment, in some variations, only one light source may be used for this application.

The light receiving devices 120 may comprise any suitable conventionally known light receiving devices, preferably photo diodes, photo transistors, photo resistors, photo diode arrays, or charge coupled devices (CCD).

The circuit 100 may comprise any suitable conventionally known circuit types, preferably printed circuit board, flex circuit or wired assembly.

The space between each adjacent light sources 110 may be from as small as a couple of millimeters or even smaller to as large as a couple of meters or even larger depending on the resolution requirement of the application. The resolution of the liquid level sensor equals to the largest space between adjacent light receiving devices 120 in that particular liquid level sensor. The resolution can be changed by changing the largest space between adjacent light receiving devices 120. The light sources 110 may be evenly spaced or unevenly spaced depending on application requirements. The same space rule applies to the light receiving devices 120.

The length of the level sensor may be as short as a couple of millimeters or even shorter to as long as a couple of meters or even longer depending on the application requirements.

The number of light sources may vary from 1 to a couple of hundreds or even more. The number of light receiving devices may vary from 2 to a couple of hundreds or even more depending on the application requirements.

The lens 200 and 200a may comprise any suitable material which is known in the art to transmit light signals therethrough, preferably glass, TOPAS® cyclic olefin-copolymer (COC) which has good chemical resistance to solvents other than non-polar solvents, TPX® brand polymethylpentene (PMP) which has excellent chemical resistance, polyvinyl chloride (PVC) which has excellent chemical and biological resistance, polymethyl methacrylate (PMMA), polycarbonates (PC), or polystyrene (PS). Although one lens is shown in the preferred embodiment, in some variations, multiple lenses may be used for this application.

The part 300 may be a solid part, a thin film or a layer of coating as long as together with lens 200 or 200a, it can prevent the circuit 100 from being in direct contact with the liquid.

The material of the part 300 may be chosen to be the same as that of the lens 200 or 200a, or different from that of the lens 200 or 200a. The part 300 may be made from any conventional material which is known in the art to be solid or form a thin film or form an insulating layer of coating. It does not have to be transparent.

The part 300 and the lens 200 or 200a may be joint together by injection molding, pressure molding, machined and then sealed together using epoxy or compressed gasket/O-rings, or any other suitable process known in the art.

The part 300 may be in any suitable shape as long as together with the lens 200 or 200a, it can hold at least a portion of the circuit 100 inside so that the circuit 100 is not in direct contact with the liquid when the liquid level sensor is immersed in the liquid. One preferred shape is rectangular.

The processor circuit 130 typically includes a mechanism for transmitting outgoing signal information to the light sources 110 electronically, and receiving reflected signal information from the light receiving devices 120 electronically.

The mechanism for processing the received signal information and calculating the level of liquid may reside on the processor circuit 130, or reside on another circuit 180 shown in FIG. 1 which communicates with the processor circuit 130 via serial or parallel interfaces.

The circuit 100 may include a power circuit to provide direct current (DC) power to all the electronic components on the circuit 100. The power may also be provided by upper level system which utilizes the liquid level sensor.

The processor circuit 130 may include a microprocessor like PIC16F877 or the like which sends outgoing signal information to all the light sources electronically at approximately the same time or sequentially in the form of a pulse or direct current (DC) signal with a chosen voltage and current. In order for the microprocessor to communicate with large quantity of light sources, the processor circuit 130 may optionally include multiplex/demultiplex Integrated circuits, coding/decoding integrated circuits. N to 1 selector circuits or serial/parallel conversion circuits. Although only one processor is shown in the preferred embodiment, in some variations, multiple processors may be used for this application.

The outgoing signal information from the processor causes all the light sources 110 to transmit outgoing light signal 140 to the optical lens 200 or 200a. The optical signal 140 is then reflected by the optical lens 200 or 200a, forming reflected light signal 150. The reflected light signal 150 is then passed to the light receiving devices 120. If the light receiving devices 120 are positioned below the liquid level, less optical signal 140 will be reflected, resulting in a weaker light signal 150 being received by the light receiving devices 120 which produces a weaker voltage or current signal. If the light receiving devices 120 are positioned above the liquid level, more optical signal 140 will be reflected due to total internal reflection, resulting in a stronger light signal 150a being received by the light receiving devices 120 which produces a stronger voltage or current signal.

The voltage or current signals from the light receiving devices 120 may be sent to the processor. Trans-impedance amplifier (TZA) or current amplifiers may be used to amplify the output signals from the light receiving devices, for example by 1000× or 10000×. Additionally, voltage threshold may be set. If there are large quantities of light receiving devices, optionally one or more N-to-1 selectors may be used to transfer signals from one light receiving device 120 to the processor at a time or transfer signals from a group of the light receiving devices 120 at a time. The signals from all the light receiving devices 120 may be received by the processor sequentially or group by group.

The processor may then analyze the received data and determine the liquid level. In a preferred embodiment, all the light sources send out light signals with approximately the same light intensity. The processor compares the received signal voltages from all the light receiving devices 120, and finds the one light receiving device H. The preferred algorithm A is as following:

a) Record the received signal voltage level of each of the light receiving devices.

b) The light receiving device H has a received signal voltage A.

c) All or at least 70% of the light receiving devices positioned above light receiving device H have received signal voltages in the range of A−F and A+F, where A is significantly larger than F.

d) All or at least 70% of the light receiving devices positioned below light receiving device H have received signal voltage in the range of B−E and B+E, where B is significantly larger than E.

e) A is significantly lower than B. B−A is significantly larger than either E or F.

f) Bubbles, current or the like may cause small disturbance to the received signal voltages of a few of the light receiving devices, usually less than 30% of the light receiving devices are affected. However such discontinuity pattern does not satisfy aforementioned criteria a) b) c), d), and e), thus bubbles, current or the like will not be thought as air-liquid interface by the algorithm.

g) The liquid level is determined to be at the middle point of the level of the light receiving device H and the level of the immediately adjacent light receiving device below H.

In a second preferred embodiment, the light sources send out light signals with various light intensities, the received signal voltage from each of the light receiving devices is divided by the sent signal voltage from the corresponding light source to form a received signal voltage ratio for each light receiving device. One can replace the received signal voltage in the aforementioned algorithm A with the received signal voltage ratio to determine the liquid level.

In addition, baseline data measurement may be performed. In a preferred embodiment, the continuous liquid level sensor is placed entirely in the air. The processor records the received signal voltages from each of the light receiving devices, assuming the voltages to be K0, K1, K2, . . . Kn respectively for the light receiving devices 0, 1, 2 . . . n. These are the baseline data. Then the liquid level sensor is placed in a vessel containing a liquid, The processor again records the received signal voltages from each of the light receiving devices, assuming the voltages to be L0, L1, L2, . . . Ln respectively for the light receiving devices 0, 1, 2 . . . n. One can subtract the baseline data from the new measured data, and add a constant K to each result to make each result a positive value. By subtracting the baseline data, device variations are eliminated. Assuming K=maximum of (K0, K1, . . . Kn), Then L0−K0+K, L1−K1+K, L2−K2+K, . . . Ln−Kn+K are used as the final received signal voltage for consideration in the aforementioned algorithm A. This method is simple. It can help to eliminate errors introduced by the light sources/light receiving devices manufacturing tolerance variations and performance shifts over time.

The above algorithm is just a preferred embodiment. Variations with the same spirit may be contemplated by those skilled in the art.

The processor may provide various user interfaces to communicate with users. The user interfaces may comprise any suitable interface, preferably analog interface, 12C, SPI, CAN, RS422, RS485, RS232, USB, 10/100/1000 base T or interfaces with custom protocols.

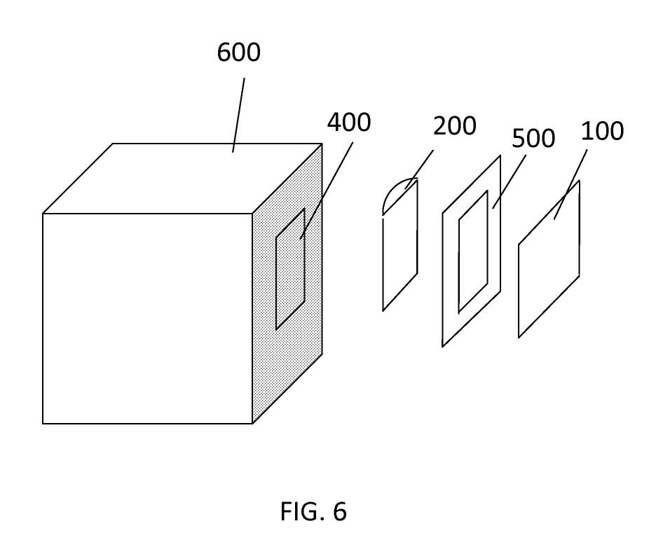

FIG. 6 is an exploded view of a third embodiment of a liquid level sensor of the invention. In this embodiment, the liquid vessel 600 has a cut-out 400 on its wall. The liquid level sensor lens 200 can be fixed at the inside of the vessel wall at the cut-out location with screws or glue or the like. The liquid level sensor circuit board 100 can be fixed at the outside of the vessel wall at the cut-out location with screws or glue or the like. A sealing gasket 500 or the like is used between the lens 200 and the circuit 100 to prevent the circuit board 100 from having direct contact with the liquid in the vessel 600. This type of liquid level sensor does not have part 300, and part 100 is placed outside of the liquid vessel 600.

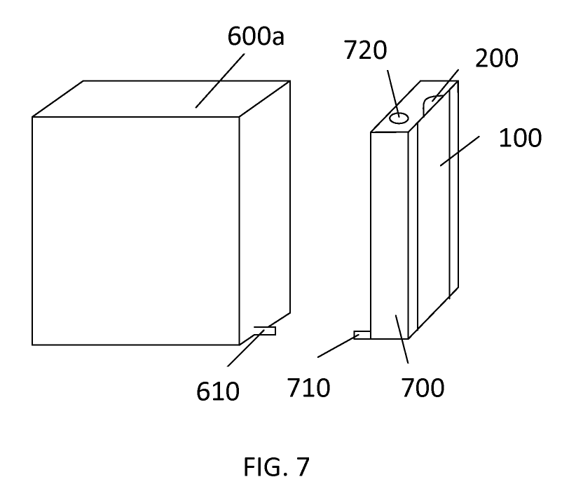

FIG. 7 is a schematic view of a fourth embodiment of a liquid level sensor of the invention. In this embodiment, the level sensor carries a thin liquid container 700. The liquid container has an inlet tube fitting 710 at the bottom, an air vent 720 at the top. A liquid vessel 600a has an inlet tube fitting 610 at the bottom. The liquid container 700 can be connected to the liquid vessel 600a through the inlet tube fitting 710 and 610. Because the liquid vessel 600a is connected to the liquid container 700 through a tube at the bottom, the liquid level in the liquid container 700 and the liquid vessel 600a will be the same. Measuring the liquid level in container 700 is equivalent to measuring the liquid level in vessel 600a. This type of liquid level sensor is entirely placed outside of the liquid vessel 600a, and it does not have part 300.

While the present invention has been particularly shown and described with reference to preferred embodiments, it will be readily appreciated by those of ordinary skills in the art that various changes and modifications may be made without departing from the spirit and scope of the invention.

What is claimed is:

1. An optical liquid level sensor which comprises:
a) one or a plurality of light sources located at various height levels, which light sources are capable of receiving signal information from at least one processor and transmitting outgoing optical signals to at least one optical lens;
b) a plurality of light receiving devices located at various height levels, which light receiving devices are capable of receiving reflected optical signals from said optical lens and sending reflected signal information to said processor or processors;
c) at least one optical lens in front of said light sources and said light receiving devices, which optical lens is capable of receiving optical signals from said light sources, forming reflected optical signals, and passing the reflected optical signals to said light receiving devices;
d) at least one processor connected to said light sources and said light receiving devices, which processor or processors are capable of transmitting outgoing signals to said light sources, receiving reflected signals from said light receiving devices, and processing related signal information.

2. The level sensor of claim 1 wherein said optical lens' cross sectional view is any shape that can result in more reflection when said section of said lens is in contact with the air than when said section of said lens is in contact with a liquid.

3. The level sensor of claim 1 wherein said optical lens is made from a suitable material which can transmit light therethrough and comprises glass, fused silica, cyclic olefin-copolymer, polymethylpentene, polyvinyl chloride, polymethyl methacrylate, polycarbonates, or polystyrene material.

4. The level sensor of claim 1 wherein said processor or processors are capable of utilizing the light receiving devices output information when said level sensor is placed entirely in the air to provide baseline information that identifies the individual base level of each said light receiving device output.

5. The level sensor of claim 1 wherein said processor or processors are capable of providing various analog or digital user interfaces.

6. A method of sensing the depth of a liquid which comprises:
I) providing an optical liquid level sensor which comprises:
a) one or a plurality of light sources located at various height levels, which light sources are capable of receiving signal information from at least one processor and transmitting outgoing optical signals to at least one optical lens;
b) a plurality of light receiving devices located at various height levels, which light receiving devices are capable of receiving reflected optical signals from said optical lens and sending reflected signal information to said processor or processors;
c) at least one optical lens in front of said light sources and said light receiving devices, which optical lens is capable of receiving optical signals from said light sources, forming reflected optical signals, and passing the reflected optical signals to said light receiving devices;
d) at least one processor connected to said light sources and said light receiving devices, which processor or processors are capable of transmitting outgoing signals to said light sources, receiving reflected signals from said light receiving devices, and processing related signal information;
II) making at least a portion of said optical lens in contact with a liquid whose level is to be measured;
III) sending outgoing signal information from said processor or processors to all said light sources, causing all said light sources transmitting outgoing light beams to said optical lens;
IV) forming reflected optical signals at said optical lens;
V) receiving said reflected optical signals into said light receiving devices;
VI) sending reflected signals information from said light receiving devices to said processor or processors; and
VII) processing the reflected signals information via said processor or processors.

7. The level sensor of claim 6 wherein said optical lens' cross sectional view is any shape that can result in more reflection when said section of said lens is in contact with the air than when said section of said lens is in contact with a liquid.

8. The level sensor of claim 6 wherein said optical lens is made from a suitable material which can transmit light therethrough and comprises glass, fused silica, cyclic olefin-copolymer, polymethylpentene, polyvinyl chloride, poly methyl methacrylate, polycarbonates, or polystyrene material.

9. The level sensor of claim 6 wherein said processor or processors are capable of utilizing the light receiving devices output information when said level sensor is placed entirely in the air to provide baseline information that identifies the individual base level of each said light receiving device output.

10. The level sensor of claim 6 wherein said processor or processors are capable of providing various analog or digital user interfaces.

11. An optical liquid level sensor which comprises:
a) a circuit which includes one or a plurality of light sources located at various height levels, which light sources are capable of receiving signal information from at least one processor and transmitting outgoing optical signals to at least one optical lens; a plurality of light receiving devices located at various height levels, which light receiving devices are capable of receiving reflected optical signals from said optical lens and sending reflected signal information to said processor or processors; and at least one processor connected to said light sources and said light receiving devices, which processor or processors are capable of transmitting outgoing signals to said light sources, receiving reflected signals from said light receiving devices, and processing related signal information;
b) at least one optical lens in front of said light sources and said light receiving devices, which optical lens is capable of receiving optical signals from said light sources, forming reflected optical signals, and passing the reflected optical signals to said light receiving devices.

12. The level sensor of claim 1 wherein said optical lens' cross sectional view is any shape that can result in more reflection when said section of said lens is in contact with the air than when said section of said lens is in contact with a liquid.

13. The level sensor of claim 11 wherein said optical lens is made from a suitable material which can transmit light therethrough and comprises glass, fused silica, cyclic olefin-copolymer, polymethylpentene, polyvinyl chloride, polymethyl methacrylate, polycarbonates, or polystyrene material.

14. The level sensor of claim 11 wherein said processor or processors are capable of utilizing the light receiving devices output information when said level sensor is placed entirely in the air to provide baseline information that identifies the individual base level of each said light receiving device output.

15. The level sensor of claim 11 wherein said processor or processors are capable of providing various analog or digital user interfaces.
